(19) United States
(12) Patent Application Publication
(10) Pub. No.: US 2024/0311905 A1
(43) Pub. Date: Sep. 19, 2024

(54) RENTAL EQUIPMENT MANAGEMENT METHOD, AND RENTAL EQUIPMENT MANAGEMENT SYSTEM

(71) Applicant: Sharp NEC Display Solutions, Ltd., Tokyo (JP)

(72) Inventor: Atsushi KONNO, Tokyo (JP)

(21) Appl. No.: 18/269,904

(22) PCT Filed: Apr. 20, 2022
(86) PCT No.: PCT/JP2022/018254

§ 371 Date: Jun. 27, 2023

(30) Foreign Application Priority Data
Apr. 21, 2021 (WO) PCT/JP2021/016168

(51) Int. Cl. G06Q 30/0645; G06F 21/31; G06Q 10/02

(52) U.S. Cl. CPC G06Q 30/0645; G06F 21/31; G06Q 10/02

(57) ABSTRACT

A rental equipment management method including: acquiring a password issued in accordance with reservation acceptance or an authentication password that is a password input from rental equipment when the rental equipment has been rented; storing the acquired authentication password and equipment identification information of the rental equipment in a storage in association with each other; receiving an input password input by a user and the equipment identification information from the rental equipment when the rental equipment is used; and determining whether or not the rental equipment is usable based on whether or not a combination of the received input password and the equipment identification information is stored in the storage.

Priority is claimed on PCT International Patent Application No. PCT/JP2021/016168, filed Apr. 21, 2021, the content of which is incorporated herein by reference.

### TECHNICAL FIELD

The present invention relates to a rental equipment management method and a rental equipment management system.

### BACKGROUND ART

There are coworking spaces which are open spaces used by people who do not have a specific office. A coworking space offers a service to rent rental equipment such as a projector for a fee. The rental equipment may be permanently installed in a public space or the rental equipment may be taken from a prescribed place and rented and used anywhere in the open space. For this reason, management is difficult when the rental equipment is used by someone other than a specific person or when the rental equipment is continuously used as it is even after the rental time. In Patent Document 1, technology for preventing unauthorized use by setting a usage permission time on a projector and restricting a function when a prescribed period has passed is described. Also, in Patent Document 2, technology for managing an expiration date of authorization information for use in an authorization process for a user is described.

However, in the above-described technology, password management in both a case where a reservation for rental equipment is made in advance and a case where same-day delivery for rental equipment is performed is not taken into account.

### CITATION LIST

### Patent Document

### [Patent Document 1]

Japanese Unexamined Patent Application, First Publication No. 2011-100376

### [Patent Document 2]

Japanese Unexamined Patent Application, First Publication No. 2016-009276

### SUMMARY OF INVENTION

### Technical Problem

There is a problem that it is difficult to appropriately manage a password and grant usage permission in both a case where a reservation for rental equipment is made in advance and a case where same-day delivery for rental equipment is performed.

### Solution to Problem

One aspect of the present invention is a rental equipment management method including: storing an authentication password for enabling rental equipment to be used in a validity period in a storage in association with equipment identification information of the rental equipment; receiving an input password input by a user from the rental equipment; and determining whether or not the rental equipment is usable based on whether or not a combination of the received input password and the equipment identification information is stored in the storage.

In addition, one aspect of the present invention is a rental equipment management method including: acquiring a password issued in accordance with reservation acceptance or an authentication password that is a password input from rental equipment when the rental equipment has been rented; storing the acquired authentication password and equipment identification information of the rental equipment in a storage in association with each other; receiving an input password input by a user and the equipment identification information from the rental equipment when the rental equipment is used; and determining whether or not the rental equipment is usable based on whether or not a combination of the received input password and the equipment identification information is stored in the storage.

In addition, one aspect of the present invention is a rental equipment management system including: a password acquirer configured to acquire a password issued in accordance with reservation acceptance or an authentication password that is a password input from rental equipment when the rental equipment has been rented; a storage configured to store the acquired authentication password and equipment identification information of the rental equipment in association with each other; and a password authenticator configured to receive an input password input by a user and equipment identification information from the rental equipment when the rental equipment is used and determine whether or not the rental equipment is usable based on whether or not a combination of the received input password and the equipment identification information is stored in the storage.

### Advantageous Effects of Invention

According to the present invention, it is possible to appropriately manage a password and grant usage permission in both a case where a reservation for rental equipment is made in advance and a case where same-day delivery for rental equipment is performed.

### BRIEF DESCRIPTION OF DRAWINGS

FIG. 1 is a schematic block diagram for describing a configuration of a rental equipment management system according to an embodiment of the present invention.

FIG. 2 is a schematic diagram showing an example of a data structure and data of a password list stored by a server.

FIG. 3 is a schematic diagram showing an example of a data structure and data of a usage reservation information table stored by a server.

FIG. 4 is a schematic diagram showing an example of a data structure and data of an equipment information table stored by the server.

FIG. 5 is an image diagram showing an example of an application of a rental equipment management system.

FIG. 6 is a flowchart for describing an operation of accepting a reservation when the reservation is made using a client terminal in the rental equipment management system.

FIG. 7 is a flowchart for describing an operation of an authentication process when rental equipment for which a usage reservation has been made is used in the rental equipment management system.

FIG. 8 is a flowchart for describing an operation of a registration process when same-day rental equipment is rented in the rental equipment management system.

FIG. 9 is a flowchart for describing an operation of a validity period extension process in the rental equipment management system.

FIG. 10 is a flowchart for describing an operation when a same-day usage procedure is performed using a control terminal.

FIG. 11 is a flowchart for describing a process performed by a server when a reservation for rental equipment including same-day use is made from a client terminal or control terminal.

FIG. 12 is a diagram showing a basic configuration of the rental equipment management system according to the present invention.

### DESCRIPTION OF EMBODIMENTS

Hereinafter, an embodiment of the present invention will be described.

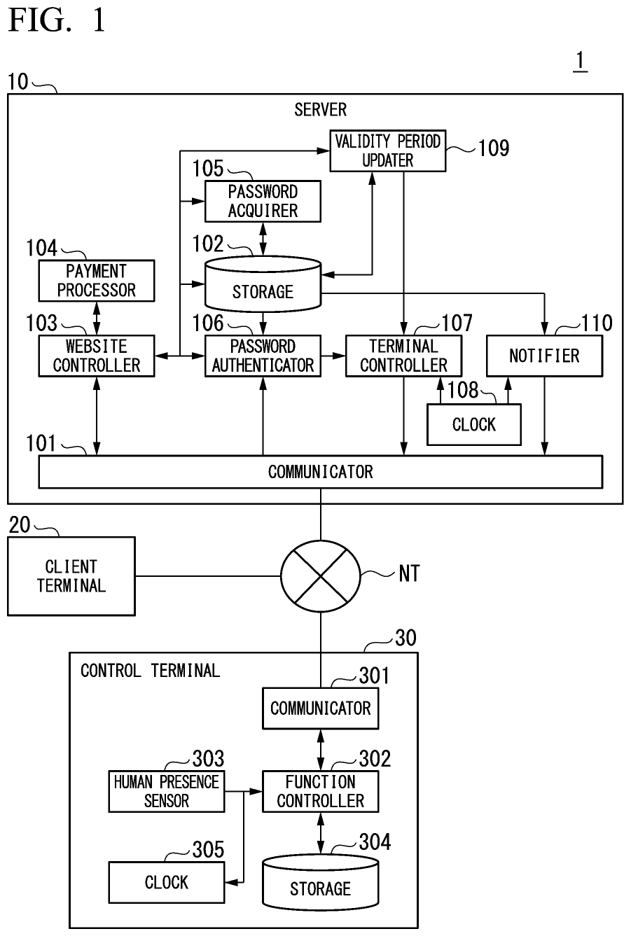

FIG. 1 is a schematic block diagram showing a configuration of a rental equipment management system according to the embodiment of the present invention. In the present embodiment, the rental equipment management system 1 is a system that manages rental equipment that has been rented to prevent unauthorized use of the rental equipment in a service for renting rental equipment such as a projector or a personal computer for a fee in a coworking space or the like.

In FIG. 1, the management system 1 includes a server 10, a client terminal 20, and a control terminal 30.

The server 10, the client terminal 20, and the control terminal 30 are communicatively connected by wire or wirelessly via a network NT.

The server 10 is a server device that generally controls the management system 1.

The client terminal 20 is a user terminal used by a user who uses the rental equipment. The client terminal 20 is, for example, a device capable of displaying a website such as a personal computer, a smartphone, or a tablet terminal.

The control terminal 30 is a program or a device mounted in rental equipment or the like and that controls the function of the corresponding rental equipment.

The server 10 includes a communicator 101, a storage 102, a website controller 103, a payment processor 104, a password acquirer 105, a password authenticator 106, a terminal controller 107, a clock 108, a validity period updater 109, and a notifier 110. The communicator 101 communicates with the client terminal 20 or the control terminal 30.

The storage 102 stores various types of information. For example, the storage 102 stores a usage reservation information table indicating a usage reservation situation of rental equipment, a password list that is a list of one-time passwords issued to the user at the time of a usage reservation, and an equipment information table indicating a model of rental equipment. A one-time password is authentication information that determines whether or not rental equipment is usable.

The website controller 103 controls a web page displayed on the client terminal by transmitting the web page data to the client terminal 20 when there is access from the client terminal 20.

The payment processor 104 executes a billing process according to contract content, a payment process based on a registered payment method, or the like when a reservation is made for the use of the rental equipment or the like.

The password acquirer 105 issues a password for which a validity period is set according to the time of use of the rental equipment to the user at the time of the reservation for use of the rental equipment or at the time of the same-day rental. Also, the password acquirer 105 writes the issued password and the equipment identification information of the rental equipment to be rented to the usage reservation information table stored by the storage 102 in association with each other. The equipment identification information is identification information for identifying rental equipment.

The password authenticator 106 receives the password and equipment identification information from the rental equipment when the user uses the rental equipment. The password authenticator 106 determines whether or not the rental equipment is usable based on whether or not a combination of the received password and equipment identification information is stored in the usage reservation information table of the storage 102.

When it is determined that the rental equipment is usable, the terminal controller 107 performs synchronization with the time of the control terminal 30 corresponding to the rental equipment by transmitting a synchronization signal. The synchronization signal includes a date and time measured by the clock 108. The terminal controller 107 transmits a login signal including a logout time to the control terminal 30 that has performed the time synchronization. The logout time is the usage end time of the rental equipment. Also, when a usage period (a password validity period) of the rental equipment is extended, the terminal controller 107 transmits a signal indicating a logout time updated based on the extended validity period to the control terminal 30.

The clock 108 measures the date and time.

When an extension request is accepted, the validity period updater 109 determines whether or not an extension is possible and extends the expiration date set for the password if the extension is possible. The expiration date is the usage period of the rental equipment. At this time, the validity period updater 109 determines that the extension is possible when other rental equipment which is of the same type as the rental equipment is usable.

The notifier 110 notifies the user of various types of information. For example, the notifier 110 notifies the user that the extension is possible when a period until the usage end time of the rental equipment is shorter than a predetermined period. Also, the notifier 110 notifies the user that the period until the usage end time of the rental equipment is shorter than the predetermined period when the period until the usage end time of the rental equipment is shorter than the predetermined period. Also, the notifier 110 notifies the user that the usage end time of the rental equipment has passed when the usage end time of the rental equipment has passed. The notifier 110 may notify the user of information by sending an e-mail message or may notify the user of information by displaying a web page from the website controller 103 to the client terminal 20. Alternatively, if the rental equipment is a device including video equipment such as a projector or a personal computer, the notifier 110 may notify the user of information by displaying the information on a screen thereof.

The control terminal 30 includes a communicator 301, a function controller 302, a human presence sensor 303, a storage 304, and a clock 305.

The communicator 301 communicates with the server 10 or the client terminal 20.

The function controller 302 controls a function of the corresponding rental equipment. For example, when a synchronization signal is received from the server 10, the function controller 302 causes a date and time measured by the clock 305 to be synchronized with a date and time indicated in the received synchronization signal. Also, the function controller 302 causes the rental equipment to be in a login state by receiving a login signal from the server 10 and cancels a restriction on the function of the rental equipment. At this time, the function controller 302 writes a logout time included in the login signal to the storage 304. Also, the function controller 302 acquires a detection result from the human presence sensor 303 at the time of a login state of the rental equipment. Also, the function controller 302 determines whether or not there is a user near the rental equipment based on the detection result of the human presence sensor 303. The function controller 302 causes the rental equipment to be in a logout state (or a logoff state) when there is no user near the rental equipment and restricts the function of the rental equipment. Also, the function controller 302 causes the rental equipment to be in the logout state when the logout time is reached and restricts the function of the rental equipment.

The human presence sensor 303 detects a person within a detection range.

The storage 304 stores various times. For example, the storage 304 stores the logout time of the rental equipment.

The clock 305 measures the date and time.

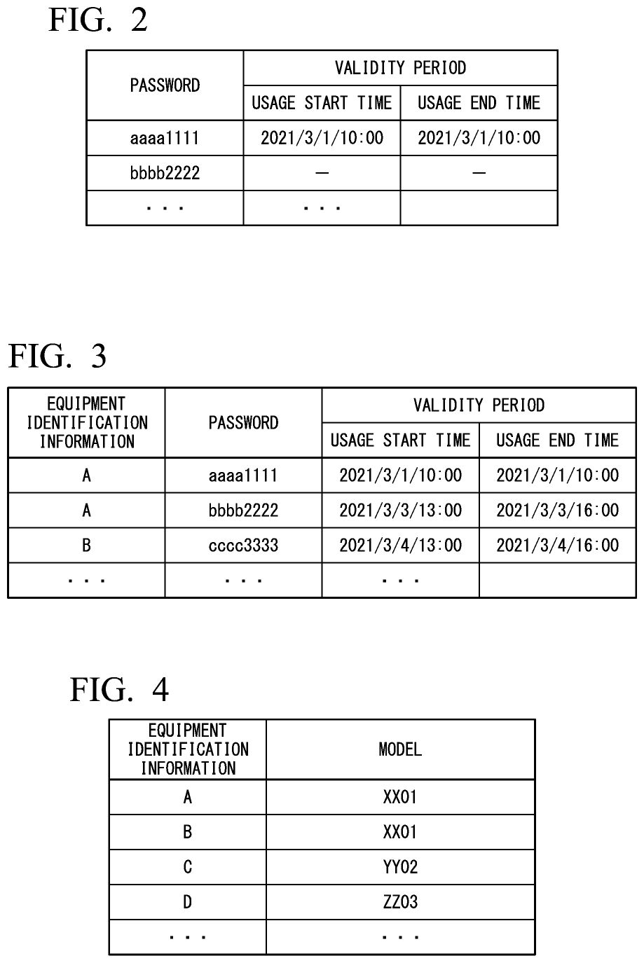

FIG. 2 is a schematic diagram showing an example of a data structure and data of a password list stored by the server.

As shown in FIG. 2, a password list stores a password and a validity period in association with each other. The password is a one-time password issued to the user. The validity period is a usage period from a usage start time of the rental equipment to a usage end time thereof. Here, the validity period “-” indicates that the validity period is not set. In the example shown in FIG. 2, the validity period of a password “aaaa1111” is a period from the usage start time of “2021/3/1/10:00” to the usage end time of “2021/3/1/12:00.” On the other hand, because there is no validity period set for the password “bbbb2222,” the validity period can be newly issued to the user.

FIG. 3 is a schematic diagram showing an example of a data structure and data of the reservation information table stored by the server.

As shown in FIG. 3, the usage reservation information table stores items of equipment identification information, a password, and a validity period in association with each other. The equipment identification information is identification information for identifying rental equipment. The password is a password for using the rental equipment. The validity period is the password validity period and the usage period of the rental equipment.

In the example shown in FIG. 3, a reservation to use the rental equipment with the equipment identification information “A” is made in a validity period from the usage start time “2021/3/1/10:00” to the usage end time “2021/3/1/12:00” and a validity period from the usage start time “2021/3/3/13:00” to the usage end time “2021/3/3/16:00.” A password for a period from “2021/3/1/10:00” to “2021/3/1/12:00” of the rental equipment with the equipment identification information “A” is “aaaa1111” and a password for a period from “2021/3/3/13:00” to “2021/3/3/16:00” is “bbbb2222.” Also, a reservation to use the rental equipment with the equipment identification information “B” is made in a validity period from the usage start time “2021/3/4/13:00” to the usage end time “2021/3/4/16:00,” and its password is “cccc3333.”

FIG. 4 is a schematic diagram showing an example of a data structure and data of an equipment information table stored by the server.

As shown in FIG. 4, the equipment information table stores items of equipment identification information and a model in association with each other. The model is a model of the rental equipment.

In the example shown in FIG. 4, the model of the rental equipment having the equipment identification information “A” is denoted by “XX01,” the model of the rental equipment having the equipment identification information “B” is denoted by “XX01,” the model of the rental equipment having the device type information “C” is denoted by “YY02,” and the model of the rental equipment having the equipment identification information “D” is denoted by “ZZ03.” That is, the model of the rental equipment having the equipment identification information “A” is the same as the model of the rental equipment having the equipment identification information “B.”

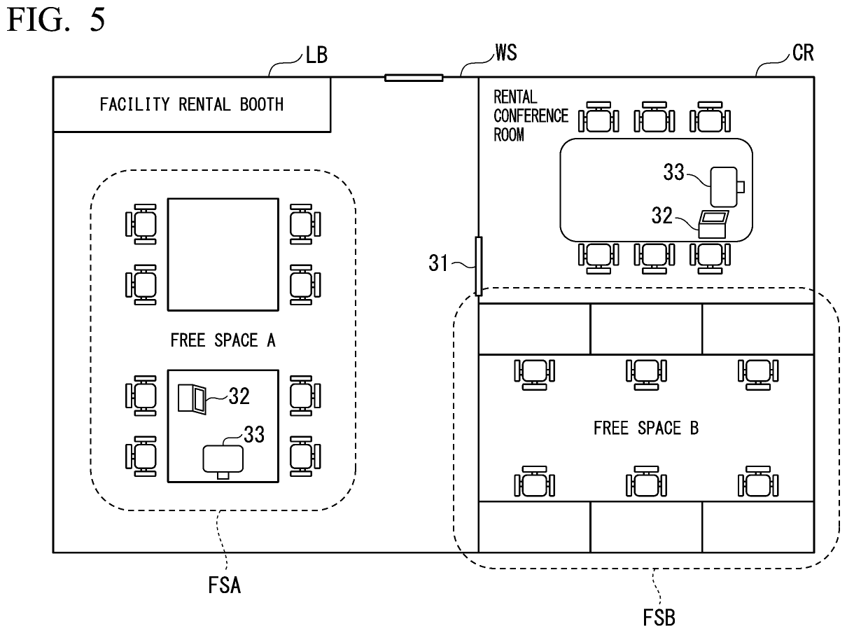

FIG. 5 is an image diagram showing an application example of the rental equipment management system.

In the example shown in FIG. 5, a case where the management system 1 is applied to a provided space WS such as a coworking space or an Internet cafe will be described. The provided space WS shown in FIG. 5 includes a free space FSA, a free space FSB, a rental conference room CR, and a facility rental booth LB. The rental conference room CR is a compartment for which a reservation can be made by designating a compartment in the provided space WS. The free space FSA and the free space FSB are compartments capable of being appropriately used as places where other users are not present without any reservation. The facility rental booth LB is a compartment where rental equipment is rented to users.

In FIG. 5, the rental conference room CR, a notebook-sized personal computer 32 that is a notebook personal computer, and a projector 33 are exemplified as the rental equipment.

When the provided space WS is used, the user can start using the rental equipment for which the user has made a usage reservation by making the reservation to use the rental equipment in advance and then performing authentication using a password from the client terminal 20. Alternatively, when the user rents the rental equipment on the same day without making a usage reservation, a lender asks the user to select one piece of rental equipment capable of being rented and rents the rental equipment. Also, the user can start using the rental equipment by setting and inputting any password in the rental equipment.

An electronic lock 31 for locking the rental conference room CR is in a state in which the door of the rental conference room CR is locked at the time of a logout state. The electronic lock 31 unlocks the door of the rental conference room CR when it is in a login state. When the user makes a reservation to use the rental conference room CR, the electronic lock 31 is in the login state and the door is unlocked by the user performing an authentication process using a password, such that the user can freely enter and exit the rental conference room CR. Also, at the time of the logout state, the electronic lock 31 is locked and entrance is not possible, but exit is possible by opening a manual lock in the rental conference room CR.

Also, when the user activates the notebook-sized personal computer 32 of the logout state, the notebook-sized personal computer 32 displays a message for notifying the user that it cannot be used without logging in on a desktop screen and a uniform resource locator (URL) or a two-dimensional code indicating a URL of a web page for performing authentication. Alternatively, when the notebook-sized personal computer 32 is activated at the time of the logout state, a message for notifying the user that it cannot be used unless a login process is performed on the desktop screen and an input form for accepting an input of a password may be displayed. Also, the user can use the notebook-sized personal computer 32 without displaying the above-described message by activating the notebook-sized personal computer 32 in the login state.

Also, when the projector 33 in the logout state has performed a projection process, a message for notifying the user that a video signal cannot be displayed unless a login process is performed and a URL of a web page for performing authentication (or a two-dimensional code indicating a URL) are displayed on a projection screen. The projector 33 displays the video signal input to a video port by performing a projection process in the login state.

Next, an operation of the management system 1 will be described.

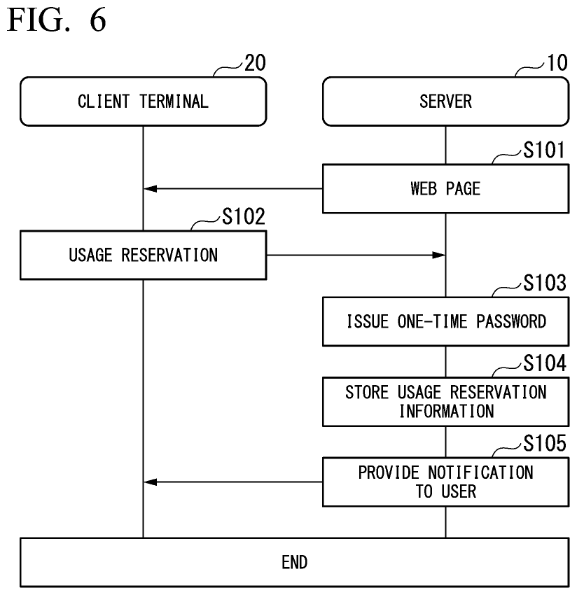

FIG. 6 is a flowchart for describing an operation of accepting a reservation when a reservation is made using a client terminal. A process shown in FIG. 6 is executed when the user makes a reservation to use the rental equipment. The user accesses a website provided by the website controller 103 of the server 10 using the client terminal 20 and makes a reservation to use the rental equipment.

When the website controller 103 accepts an access from the client terminal 20, the website controller 103 of the server 10 reads a current reservation situation from the usage reservation information table stored by the storage 102 and transmits a web page indicating the read reservation situation to the client terminal 20 (step S101). The client terminal 20 displays the received web page on the display screen. Thereby, the user can confirm the rental equipment for which a reservation can be made with reference to the reservation situation displayed on the display screen of the client terminal 20.

The client terminal 20 accepts an input of usage reservation information from the web page received from the server 10. The user selects rental equipment desired to be used and its usage period (a usage start time and a usage end time) and makes a usage reservation by inputting payment method information to the web page. At this time, the user can also input his or her e-mail address. The client terminal 20 transmits the usage reservation information input to the web page to the server 10 (step S102). The website controller 103 of the server 10 receives the usage reservation information.

The payment processor 104 of the server 10 executes a payment process based on the received usage reservation information. The password acquirer 105 issues a one-time password when the payment process is completed (step S103). Specifically, the password acquirer 105 selects and issues a password for which the usage period and the validity period included in the usage reservation information do not overlap from the password list stored by the storage 102. For example, the password acquirer 105 selects a password for which no validity period is set.

The password acquirer 105 writes the issued one-time password, the equipment identification information of the rental equipment indicating the received usage reservation information, and the usage period included in the received usage reservation information to the usage reservation information table stored by the storage 102 in association with each other. Thereby, the storage 102 stores the equipment identification information of the rental equipment for which a usage reservation is made, the password, and the usage period (the password validity period) for which a usage reservation has been made in association with each other (step S104). Also, the password acquirer 105 writes a validity period corresponding to the issued one-time password to the password list.

The notifier 110 transmits the issued one-time password and the equipment identification information of the rental equipment for which a usage reservation is made to the client terminal 20 and notifies the user thereof (step S105). The notifier 110 may provide a notification to the user by displaying the password and the equipment identification information on the web page via the website controller 103 or may provide a notification to the user by transmitting an email containing the password and equipment identification information to the e-mail address input at the time of a usage reservation or the like.

In this way, because the management system 1 performs a usage reservation or payment procedure online, the management of rental of rental equipment can be automated and labor costs can be suppressed.

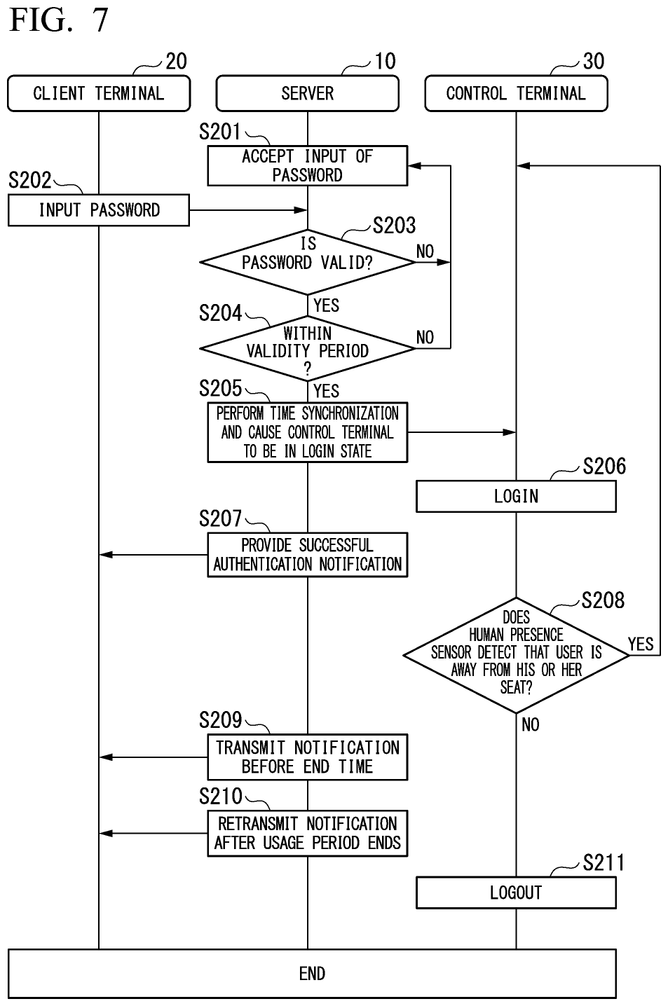

FIG. 7 is a flowchart for describing an operation of an authentication process when rental equipment for which a usage reservation has been made is used in the rental equipment management system. The process shown in FIG. 7 is executed when the user uses the rental equipment for which a usage reservation has been made. The user accesses the website provided by the website controller 103 of the server 10 using the client terminal 20 and performs authentication for using the rental equipment.

When the website controller 103 accepts an access from the client terminal 20, the website controller 103 of the server 10 transmits a web page for accepting the input of the password to the client terminal 20 (step S201).

The client terminal 20 displays the received web page on the display screen and accepts the input of the password (step S202). The user inputs the password and the equipment identification information provided in the notification at the time of a usage reservation. The client terminal 20 transmits the password and the equipment identification information input in the web page to the server 10. The website controller 103 of the server 10 receives the password and the equipment identification information from the client terminal 20.

The password authenticator 106 of the server 10 determines whether or not the received password is valid (step S203). Specifically, the password authenticator 106 determines that the password is valid when a combination of the received password and the equipment identification information matches that stored in the usage reservation information table. When the website controller 103 determines that the password is not valid (step S203: No), the website controller 103 transmits a web page for notifying that authentication has failed to the client terminal 20 and returns to the processing of step S201.

On the other hand, when the password authenticator 106 of the server 10 determines that the password is valid (step S203: Yes), the password authenticator 106 reads the validity period of the received password from the usage reservation information table and determines whether or not the current date and time is within the validity period (step S204). When the current date and time is outside of the validity period (step S204: No), the website controller 103 transmits a web page for notifying that the validity period is outside of the validity period to the client terminal 20 and returns to the processing of step S201.

On the other hand, when the current date and time is within the validity period (step S204: Yes), the terminal controller 107 of the server 10 performs time synchronization by transmitting a synchronization signal to the control terminal 30 corresponding to the rental equipment. When the synchronization signal is received, the function controller 302 of the control terminal 30 causes a date and time measured by the clock 305 to be synchronized with a date and time indicated in the received synchronization signal. Subsequently, the terminal controller 107 of the server 10 transmits a login signal including the logout time to the control terminal 30 (step S205).

When the login signal is received, the function controller 302 of the control terminal 30 writes a logout time included in the login signal to the storage 304. Thereby, the storage 304 stores the logout time. Also, the function controller 302 causes the rental equipment to be in the login state and cancels a restriction on the function of the rental equipment (step S206). Thereafter, the function controller 302 notifies the server 10 that the synchronization has been successful.

When the notifier 110 of the server 10 receives a successful synchronization notification from the control terminal 30, the notifier 110 notifies the user that authentication has been successful (step S207). For example, the notifier 110 provides the notification to the user by transmitting a web page for notifying that authentication has been successful to the client terminal 20 via the website controller 103. Alternatively, the notifier 110 may transmit the notification by e-mail. Alternatively, when the rental equipment is a device including video equipment such as a personal computer or a projector, the notifier 110 may cause its screen to display the notification.

On the other hand, after the rental equipment is allowed to be in the login state, the function controller 302 of the control terminal 30 starts detection by the human presence sensor 303 and determines whether or not the user is away from his or her seat (or whether there is a user near the rental equipment) (step S208). For example, the function controller 302 determines that the user is away from his or her seat when the human presence sensor 303 detects that there is no person within the detection range for a certain period or more. When it is determined that the user is not away from his or her seat (step S208: No), the function controller 302 maintains the login state of the rental equipment and continues detection by the human presence sensor 303. On the other hand, when it is determined that the user is away from his or her seat (step S208: Yes), the function controller 302 ends the detection by the human presence sensor 303, causes the rental equipment to be in the logout state, and restricts the function of the rental equipment.

When a period until the usage end time is shorter than a prescribed period, the notifier 110 of the server 10 notifies the user that the usage end time is near and that the user is prompted to leave (step S209). At this time, the notifier 110 also notifies that an extension procedure is possible when the control terminal 30 does not have the next usage reservation. For example, the notifier 110 may display a notification on the client terminal 20 or transmit a notification by e-mail. Alternatively, when the rental equipment is a device including video equipment such as a personal computer or a projector, the notifier 110 may cause its screen to display a notification.

Also, the notifier 110 of the server 10 notifies the user that the usage end time has passed when the usage end time has passed (step S210).

On the other hand, the function controller 302 of the control terminal 30 causes the rental equipment to be in the logout state when the date and time measured by the clock 305 becomes the logout time and restricts the function of the rental equipment (step S211). Thereby, after the usage end time, the rental equipment is allowed to be automatically in the logout state and cannot be used.

Although a password and equipment identification information for authentication are input from the client terminal 20 in the authentication process shown in FIG. 7, the present invention is not limited thereto and the rental equipment may accept the input of the password and the equipment identification information and transmit the password and the equipment identification information to the server 10.

In an open space where there are an unspecified number of people, there is a possibility that the rental equipment may be illegally used by a person other than the user while the user is away from his or her seat or the rental equipment may be continuously used as it is even though the usage period has passed. In response to such problems, in this management system 1, by performing authentication with a password valid only for a specific period issued in advance, it is possible to prevent the rental equipment from being continuously used as it is even though the usage period has passed. Also, because the control terminal 30 is allowed to be in the logout state and restricts the function of the rental equipment when a person's absence is detected based on a detection result of the human presence sensor 303, it is possible to prevent a person other than the user from illegally using the rental equipment while the user is away from his or her seat.

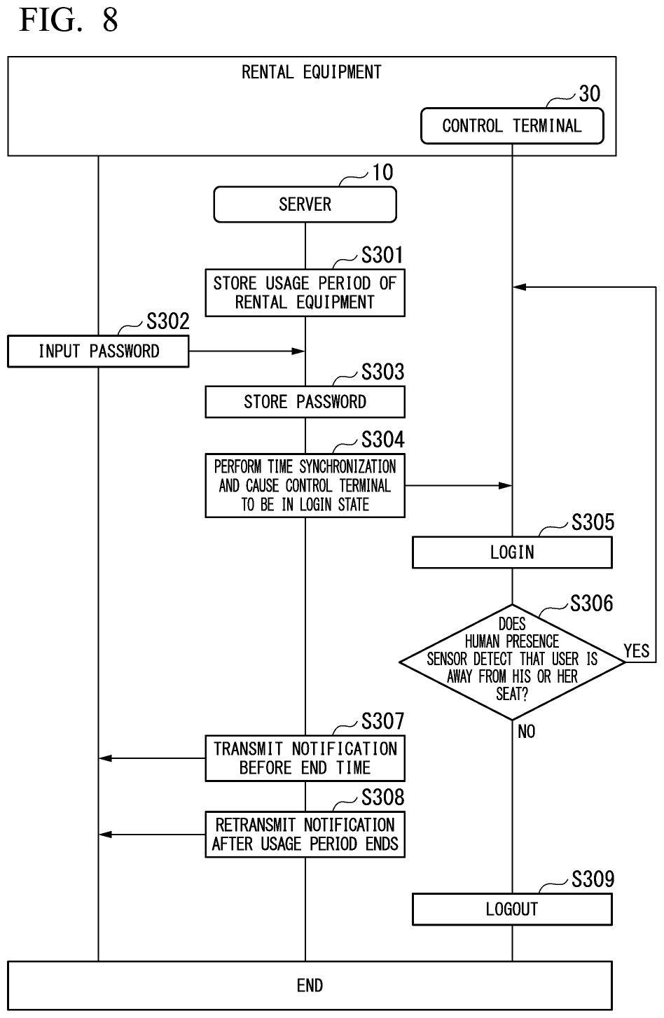

FIG. 8 is a flowchart for describing an operation of a registration process when the same-day rental for the rental equipment is performed in the rental equipment management system. The process shown in FIG. 8 is executed when the rental equipment is rented and used by the user at the facility rental booth LB on the same day.

The storage 102 of the server 10 stores equipment identification information of the rental equipment rented to the user and a usage period (a password validity period thereof) in the usage reservation information table (step S301).

When the user activates the rented rental equipment, the rental equipment accepts an input of a password (step S302). The user sets and inputs any password. Alternatively, when the rental equipment can detect identification information of a smartphone held by the user or the like, the rental equipment may capture the identification information as a password. The rental equipment transmits the input password and equipment identification information of its own device to the server 10.

The password acquirer 105 of the server 10 receives the password and the equipment identification information from the rental equipment and writes the received password to the usage reservation information table stored by the storage 102 in association with the equipment identification information and the expiration date stored in step S301. Thereby, the storage 102 stores the equipment identification information and validity period stored in step S301 and the received password in association with each other (step S303).

Subsequently, the terminal controller 107 of the server 10 performs time synchronization by transmitting a synchronization signal to the control terminal 30 corresponding to the rental equipment. When the synchronization signal is received, the function controller 302 of the control terminal 30 causes a date and time measured by the clock 305 to be synchronized with a date and time indicated in the received synchronization signal. Subsequently, the terminal controller 107 of the server 10 transmits a login signal including a logout time to the control terminal 30 (step S304).

When the login signal is received, the function controller 302 of the control terminal 30 writes the logout time included in the login signal to the storage 304. Thereby, the storage 304 stores the logout time. Also, the function controller 302 causes the rental equipment to be in the login state and cancels the restriction on the function of the rental equipment (step S305).

Because the processing of steps S306 to S309 is similar to the above-described processing of steps S208 to S211, description thereof will be omitted.

Also, when the rental equipment is in the logout state due to a case where the user is away from his or her seat or the like, it is possible to set the state of the rental equipment as the login state and reuse the rental equipment by reinputting a password provided in the notification at the time of a usage reservation or a password set and input by the user in step S302 to the rental equipment. At this time, the rental equipment transmits the reinput password to the server 10 together with the equipment identification information of its own device. The server 10 executes the above-described processing of steps S203 to S205 to reset the state of the rental equipment as the login state.

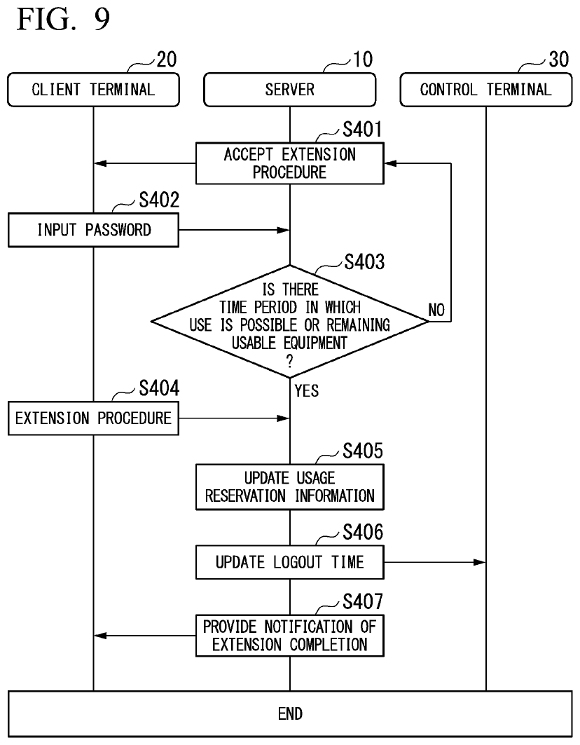

FIG. 9 is a flowchart for describing an operation of a validity period extension process in the rental equipment management system. The process shown in FIG. 9 is executed when the user extends the usage period of the rental equipment. The user accesses a website provided by the website controller 103 of the server 10 using the client terminal 20 and extends the usage period (the password validity period) of the rental equipment.

When the website controller 103 accepts an access from the client terminal 20, the website controller 103 of the server 10 transmits a web page for accepting the extension of a usage period to the client terminal 20 (step S401).

The client terminal 20 displays the received web page on the display screen and accepts an input of a password and equipment identification information (step S402). The user inputs a password and equipment identification information. The client terminal 20 transmits the password and the equipment identification information input to the web page to the server 10. The website controller 103 of the server 10 receives the password and the equipment identification information from the client terminal 20.

The password authenticator 106 of the server 10 authenticates the password by performing processing similar to the above-described processing of steps S203 and S204. When the password authentication has been successful, the validity period updater 109 reads the usage reservation information table, makes an inquiry about a current usage reservation situation, and determines whether or not an extension is possible (step S403). When another usage reservation is made during an extended time period, the validity period updater 109 identifies other rental equipment which is of the same type as the rental equipment based on the equipment information table stored by the storage 102. Also, the validity period updater 109 determines the remaining number of pieces of other specified rental equipment for which a usage reservation has not been made in the same time period. The validity period updater 109 determines that the extension is possible when there are no other usage reservations during the extended time period or when there is rental equipment of the same type for which a usage reservation has not been made in the same time period. On the other hand, the validity period updater 109 determines that extension is not possible when another usage reservation is made during the extended time period and there is no rental equipment of the same type for which a usage reservation has not been made in the same time period. When the website controller 103 determines that the extension is not possible (step S403: No), the website controller 103 transmits a web page for notifying that the extension is not possible to the client terminal 20 and returns to the processing of step S401.

On the other hand, when it is determined that the extension is possible (step S403: Yes), the website controller 103 transmits a web page for performing an extension procedure to the client terminal 20. The client terminal 20 displays the received web page and accepts the extension procedure (step S404). The user can perform the extension procedure by designating the usage period to be extended from the web page displayed on the client terminal 20 and inputting payment method information. The client terminal 20 transmits the input extension information to the server 10. The website controller 103 of the server 10 receives the extension information.

The payment processor 104 of the server 10 executes the payment process based on the received extension information. When the payment process is completed, the validity period updater 109 rewrites the validity period corresponding to the authenticated password and equipment identification information based on the received extension information. Thereby, the validity period corresponding to the authenticated password and equipment identification information is updated in the usage reservation information table stored by the storage 102 (step S405). Also, if another usage reservation is made during the extended time period, the validity period updater 109 will make another usage reservation for other rental equipment which is of the same type as the rental equipment for which a usage reservation has not been made in the same time period. Specifically, the validity period updater 109 associates the password and the expiration date of the other usage reservation with the equipment identification information of the other rental equipment and writes an association result to the usage reservation information table.

When the current date and time is within the extended usage period, the terminal controller 107 of the server 10 performs time synchronization by transmitting a synchronization signal to the control terminal 30 of the rental equipment whose usage period has been extended. The terminal controller 107 transmits a signal indicating the updated logout time (usage end time) to the control terminal 30. When the function controller 302 of the control terminal 30 receives a signal indicating the logout time, the logout time stored by the storage 304 is rewritten to the logout time indicated in the signal. Thereby, the logout time stored by the storage 304 is updated (step S406). Subsequently, the function controller 302 notifies the server 10 that the synchronization has been successful.

When a successful synchronization notification is received from the control terminal 30, the website controller 103 of the server 10 transmits a web page for notifying that the extension of the usage period of the rental equipment has been completed to the client terminal 20 (step S407).

Although the procedure for extending the usage period of the rental equipment is performed from the client terminal 20 in the process shown in FIG. 9, the present invention is not limited thereto and the usage period extension procedure may be performed from the rental equipment when the rental equipment is a device capable of displaying a web page such as a personal computer, a tablet terminal or a smartphone.

Thus, according to the present embodiment, the rental equipment management system 1 acquires a password issued in accordance with reservation acceptance or a password input from rental equipment when the rental equipment has been rented (an authentication password), stores the acquired password and equipment identification information of the rental equipment in the storage 102 in association with each other, receives a password (an input password input by a user) and the equipment identification information from the rental equipment when the rental equipment is used, and determines whether or not the rental equipment is usable based on whether or not a combination of the received password and the equipment identification information is stored in the storage 102. Thereby, it is possible to manage a password and grant usage permission in both a case where a reservation for rental equipment is made in advance and a case where the same-day delivery for rental equipment is performed.

Also, according to the present embodiment, the rental equipment management system 1 acquires a detection result from a sensor, determines whether or not the user is located near the rental equipment based on the detection result of the sensor, and causes the rental equipment to be in a logoff state when there is no user near the rental equipment. Thereby, because the rental equipment is allowed to be automatically in a logout state when the user leaves the rental equipment, it is possible to prevent unauthorized use of the rental equipment by another person while the user is away from his or her seat.

Although a human presence sensor 303 provided in the control terminal 30 is shown as an example of a sensor in the present embodiment, the present invention is not limited thereto as long as it can be determined that the user has left the rental equipment. For example, when the rental equipment is a personal computer, a person may be detected by performing an imaging process with a camera provided in the personal computer and determining whether or not a person is included in the captured image. Also, when the rental equipment is a projector, the projector may have a built-in human presence sensor or a human presence sensor may be retrofitted to the projector.

When the human presence sensor is not mounted in the rental equipment, a human presence sensor provided outside of the rental equipment may be used. In this case, the human presence sensor is (1) a human presence sensor installed on a ceiling or the like and configured to detect a person using the presence or absence of human movement, (2) a human presence sensor configured to detect that there is a person when a light is turned on in a rented compartment, (3) a sensor configured to detect that the user enters/leaves the room by opening and closing the door, or the like. When a human presence sensor provided outside of the rental equipment is used, the server 10 associates the nearest human presence sensor and the rental equipment at a location when the user first logs in to the rental equipment. Also, the server 10 determines whether or not there is a user near the rental equipment based on the detection result of the associated human presence sensor. Alternatively, the server 10 may input a compartment to be used at the time of a usage reservation or the like and associate the human presence sensor provided in a compartment for which a reservation has been made with the rental equipment. For example, when the compartment for which a reservation has been made is a free space, the server 10 performs the association with a human presence sensor that differs according to whether it is a free space FSA or a free space FSB.

For example, when the projector of the rental equipment is fixed to a fixed object (ceiling or wall) with a screw or the like, the compartment and the projector are associated, such that the server 10 can associate the human presence sensor installed in the compartment and the projector. Also, the server 10 associates the personal computer and the projector when a portable type projector has been rented together with the personal computer. Also, the server 10 causes the projector to be in the logout state in conjunction with the personal computer in accordance with whether or not a person has been detected in the personal computer rented together with the projector.

A human presence sensor can be used to detect whether or not a user using the rental equipment is present nearby, but a function of detecting the user's position as a sensor may be used in addition to this. In the function of detecting the user's position, position information may be acquired from a Global Positioning System (GPS) device owned by the user or an access point that a device such as a smartphone owned by the user accesses by communication may be identified and a location where the access point has been installed may be used as position information.

Also, the rental equipment management system 1 according to the present embodiment determines whether or not the extension is possible when an extension request is accepted and extends an expiration date set for a password (an authentication password) when the extension is possible. At this time, if other rental equipment which is of the same type as the rental equipment can be used, it is determined that the extension is possible. Thereby, even if the next usage reservation is made for the rental equipment currently being used by the user, the usage period of the rental equipment is extended and the user can continuously use the rental equipment currently in use when the usage reservation is not made for other rental equipment of the same model.

Also, the rental equipment management system 1 according to the present embodiment performs synchronization with a time of the rental equipment and causes the rental equipment to be in the logoff state after the expiration date set with respect to the password (authentication password). Thereby, for example, even if a failure or a communication failure occurs in the server 10 during the use of the rental equipment, the control terminal 30 provided in the rental equipment manages the usage end time and the rental equipment can be automatically in a logout state after the usage end time.

Also, the rental equipment management system 1 according to the present embodiment sets a validity period according to a usage period of the rental equipment in the password (the authentication password) and determines that the rental equipment is usable only when the received password (the authentication password corresponding to the input password) is within the validity period. Thereby, because the rental equipment cannot be used outside of the validity period, it is possible to prevent unauthorized use of the rented rental equipment.

Also, the rental equipment management system 1 according to the present embodiment notifies the user that a period until an expiration date set for the password (the authentication password) is shorter than a prescribed period if the period until the expiration date is shorter than the prescribed period. Thereby, because the user can know that the usage end time of the rental equipment is near, the extension procedure can be performed as necessary.

Also, the rental equipment management system 1 according to the present embodiment notifies the user that an expiration date set for the password (authentication password) has passed when the expiration date has passed. Thereby, the user can know that the rental equipment can no longer be used because the usage period of the rental equipment has passed.

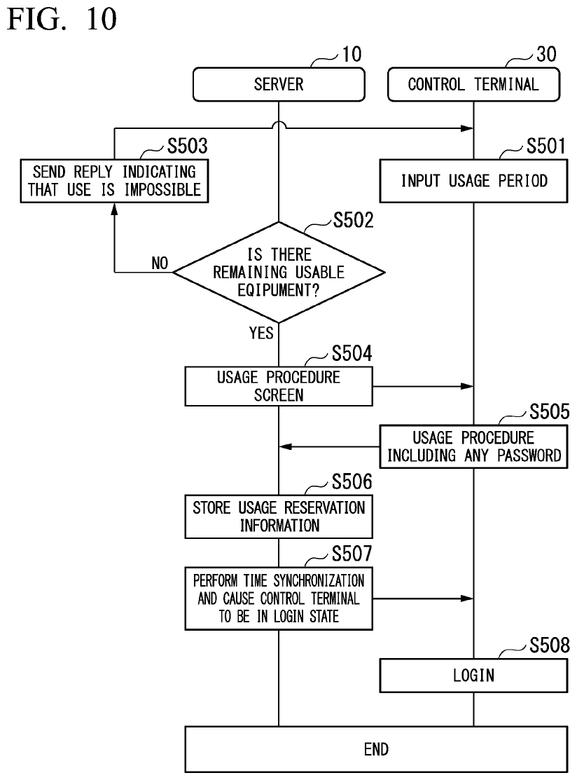

FIG. 10 is a flowchart for describing an operation of a usage procedure when the same-day rental equipment using the control terminal 30 is used. A process shown in FIG. 10 is executed when the user rents and uses rental equipment using the same-day rental equipment.

When the website controller 103 accepts an access from the control terminal 30, the website controller 103 of the server 10 transmits a web page for accepting the user's desired usage period to the control terminal 30. The control terminal 30 displays the received web page on the display screen and accepts the input of a usage period from the web page received from the server 10. The user selects the usage period (a usage start time and a usage end time) in which he or she desires to use rental equipment and performs the usage procedure by inputting payment method information to the web page (step S501). The control terminal 30 transmits the usage period input to the web page to the server 10. The website controller 103 of the server 10 receives the usage period.

The website controller 103 reads a usage reservation information table, makes an inquiry about a current usage reservation situation, and determines whether or not the rental equipment corresponding to the control terminal 30 can be used in a time period when the user desires to use the rental equipment (step S503). When another usage reservation is made in the same time period, the website controller 103 identifies other rental equipment which is of the same type as the rental equipment based on the equipment information table stored by the storage 102. Also, the website controller 103 determines the remaining number of pieces of other specified rental equipment for which a usage reservation has not been made in the same time period.

The website controller 103 determines that rental equipment can be used when there is no other usage reservation in the same time period or when there is rental equipment of the same type for which a usage reservation has not been made in the same time period. On the other hand, the website controller 103 determines that it cannot be used when there is another usage reservation in the time period that the user desires to use rental equipment and there is no rental equipment of the same type for which a usage reservation has not been made in the same time period. When the website controller 103 determines that rental equipment is unusable (step S502: No), the website controller 103 transmits a web page for notifying that rental equipment cannot be used to the control terminal 30 (step S503) and returns to the processing of step S501.

On the other hand, when the website controller 103 determines that rental equipment can be used (step S502: Yes), the website controller 103 transmits a web page for performing the usage procedure to the client terminal 20. The client terminal 20 displays the received web page and accepts the usage procedure (step S505). The user can perform the usage procedure by setting and inputting any password and inputting payment method information from the web page displayed on the control terminal 30.

The control terminal 30 transmits the input password and payment method information to the server 10. The website controller 103 receives the password and the payment method information. The payment processor 104 of the server 10 executes a payment process based on the received payment method information. When the payment process is completed, the password acquirer 105 of the server 10 writes the received password, the equipment identification information of the rental equipment corresponding to the control terminal indicated in the notification of the password, and the usage period input in step S501 to the usage reservation information table stored in the storage 102 in association with each other. Thereby, the storage 102 stores the equipment identification information of the rental equipment for which the usage procedure has been performed, the password, and the usage period (password validity period) for which the usage procedure has been performed in association with each other (step S506). Also, the password acquirer 105 writes a validity period corresponding to the password received from the control terminal 30 to the password list.

As in step S205, the terminal controller 107 of the server 10 performs time synchronization by transmitting a synchronization signal to the control terminal 30 corresponding to the rental equipment and transmits a login signal including the logout time to the control terminal 30 (step S507). As in step S206, the function controller 302 of the control terminal 30 writes the logout time included in the received login signal to the storage 304, causes the rental equipment to be in a login state, and cancels a restriction on a function of the rental equipment (step S508).

In this case, the server 10 may notify the client terminal 20 that the rental equipment is usable when the control terminal 30 is notified that the login has been successful. Also, as in step S208, the function controller 302 of the control terminal 30 may start detection by the human presence sensor 303 after causing the rental equipment to be in the login state.

Thus, because the management system 1 can perform a same-day usage procedure and a payment procedure online, the management of rental of rental equipment can be automated and labor costs can be suppressed.

Although the usage period is input from the control terminal 30 in step S501 shown in FIG. 10, the present invention not limited thereto and a terminal provided in the facility rental booth LB (referred to as a provided terminal) may accept the input of the usage period of the rental equipment and transmit the usage period input by the user to the server 10. In this case, in step S505, the provided terminal may transmit any password set and input by the user to the server 10.

Also, in step S501, the client terminal may accept the input of the usage period and transmit the usage period input by the user to the server 10. In this case, in step S505, the client terminal 20 may transmit any password set and input by the user to the server 10.

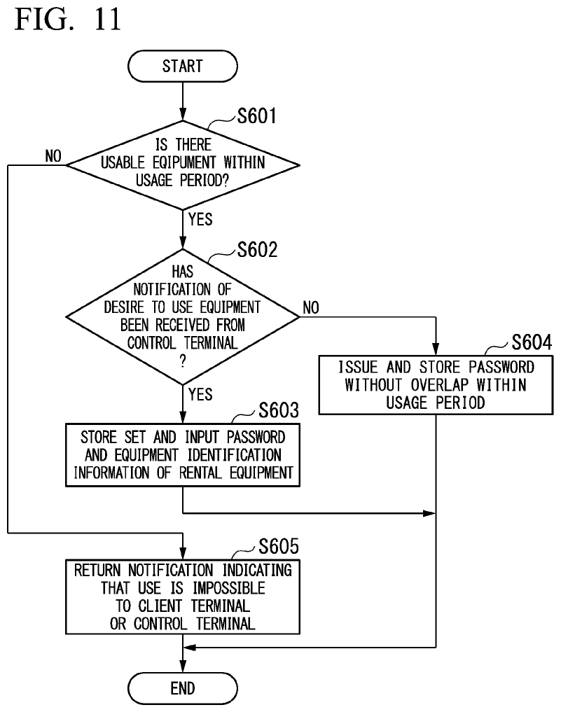

FIG. 11 is a flowchart for describing a process performed by the server when a notification of the desire to use rental equipment including a usage reservation and same-day use is sent from the client terminal 20 or the control terminal 30.

The website controller 103 of the server 10 determines whether or not the rental equipment is usable during a time period in which the user desires to use the rental equipment (step S601). When usage reservation information has been received from the client terminal 20, the website controller 103 determines the remaining number of pieces of rental equipment for which a usage reservation has not been made in the same time period among pieces of rental equipment desired to be used by the user and determines that rental equipment is usable when there is rental equipment for which a usage reservation has not been made. On the other hand, when the usage period has been received from the control terminal 30, the website controller 103 determines that the rental equipment corresponding to the control terminal 30 is usable when there is no usage reservation in the same time period. Alternatively, when a usage reservation for rental equipment corresponding to the control terminal 30 has been made in the same time period, the website controller 103 determines the remaining number of pieces of rental equipment for which a usage reservation has not been made in the same time period among pieces of other rental equipment which is of the same type as the rental equipment and determines that rental equipment is usable when there is rental equipment of the same type for which a usage reservation has not been made.

When the rental equipment is usable (step S601: Yes), the website controller 103 determines whether or not a notification of the desire to use the rental equipment has been provided from the control terminal 30 (step S602). When the notification of the desire to use the rental equipment has been provided from the control terminal 30 or the rental equipment (step S602: Yes), the website controller 103 causes the usage reservation information table stored by the storage 102 to store a password set and input by the user with equipment identification information of the rental equipment and a usage period of the rental equipment in association with each other (step S603). That is, when a password corresponding to the desire to use the rental equipment has not been issued, the website controller 103 acquires the password set and input by the user from the control terminal 30 and causes the usage reservation information table stored by the storage 102 to store the acquired password.

On the other hand, when the notification of the desire to use the rental equipment is not provided by the control terminal 30 or the rental equipment, i.e., the notification of the desire to use the rental equipment is provided from the client terminal 20 (step S602: No), the password acquirer 105 of the server 10 selects and issues a password whose validity period does not overlap that of the password issued for the use of other rental equipment for use in the same time period and causes the usage reservation information table stored by the storage 102 to store one issued password and the equipment identification information and the usage period of the rental equipment in association with each other (step S604). That is, when the notification of the desire to use the rental equipment has been accepted from the client terminal 20, the password acquirer 105 issues a password in accordance with a usage desire without accepting the password set and input from the user and causes the usage reservation information table stored by the storage 102 to store the issued password.

On the other hand, in step S601, when the rental equipment is not usable (step S601: No), the website controller 103 notifies the user that the rental equipment is not usable. When the usage reservation information has been received from the client terminal 20, the website controller 103 notifies the client terminal 20 that the rental equipment is unusable. On the other hand, when the usage period has been received from the control terminal 30, the website controller 103 notifies the control terminal 30 that the rental equipment is unusable.

Also, when the rental equipment is a device including a communication device such as a personal computer, the website controller 103 may determine whether or not a notification of the desire to use the rental equipment has been provided from the rental equipment in step S602. In this case, in step S603, the website controller 103 acquires the password set and input by the user from the rental equipment and causes the usage reservation information table stored by the storage 102 to store the acquired password.

Also, in step S601, when the notification of the usage desire including a time period in which the user desires to use the rental equipment has been accepted, the website controller 103 may accept a password for which a time at which the notification of the usage desire was accepted is included in a time period in which the user desires to use the rental equipment, i.e., a password set and input by the user when the same-day use is desired. In this case, the website controller 103 accepts the time period in which the user desires to use the rental equipment, determines whether or not the rental equipment is usable from a usage reservation situation, acquires the password set and input by the user from the control terminal 30 when it is determined that the rental equipment is usable and when the time at which the notification of the usage desire was accepted is included in the time period in which the user desires to use the rental equipment, and causes the usage reservation information table stored by the storage 102 to store the acquired password.

Alternatively, in step S601, when the notification of the usage desire including the time period in which the user desires to use the rental equipment has been accepted and when there is rental equipment for which a usage reservation has not been made, i.e., when there is rental equipment (usable rental equipment) for which a password is not issued included in the time period in which the user desires to use the rental equipment, a procedure for using the rental equipment may be accepted from the client terminal 20 and the rental equipment. In this case, the website controller 103 accepts a time period in which the user desires to use the rental equipment and determines whether or not there is usable rental equipment. When there is usable rental equipment, the website controller 103 accepts a procedure (a usage procedure) for using the rental equipment from the client terminal 20 and the rental equipment. When the usage procedure is performed from the client terminal 20, the server 10 executes the process shown in step S604.

When the usage procedure is performed from the rental equipment, the server 10 executes the process shown in step S603.

Thus, the rental equipment management system 1 according to the present embodiment stores a password (an authentication password) for enabling rental equipment to be used in a validity period in the storage 102 in association with equipment identification information of the rental equipment, receives a password (an input password) input by a user and the equipment identification information from the rental equipment when the rental equipment is used, and determines whether or not the rental equipment is usable based on whether or not a combination of the received input password and the equipment identification information is stored in the storage 102. Thereby, it is possible to appropriately permit the use of the rental equipment during the validity period.

Also, the rental equipment management system 1 according to the present embodiment accepts a password (a set password) set and input by the user as the password (the authentication password) for enabling the rental equipment to be used in the validity period when a password (an issued password) to be issued in accordance with a desire to use the rental equipment has not been issued. Thereby, the password set and input from the user can be set as the authentication password in accordance with whether or not the password has been issued.

Also, the rental equipment management system 1 according to the present embodiment accepts the password (the issued password) issued in accordance with the desire to use the rental equipment as the password (the authentication password) for enabling the rental equipment to be used in the validity period without accepting the password (the set password) set and input from the user when a notification of the desire to use the rental equipment (a usage request) has been accepted from a client terminal 20. Thereby, in accordance with the terminal that has provided the notification of the desire to use the rental equipment, the password radiated by the server 10 can be set as the authentication password instead of the password set and input from the user.

Also, in the rental equipment management system 1 according to the present embodiment, a password (setting password) set and input from the user is received from the rental equipment. Thereby, a password can be set from the rental equipment and a notification of the desire to use the rental equipment can be accepted more efficiently than in a case where the rental equipment is used via the client terminal 20 when the rental equipment is used on the same day or the like.

Also, the rental equipment management system 1 according to the present embodiment determines whether or not the rental equipment is usable from a usage reservation situation of the rental equipment when a time period (a desired usage period) in which the use of the rental equipment is desired by the user has been accepted. The password (the set password) set and input from the user is accepted as the password (the authentication password) for enabling the rental equipment to be used in the validity period when it is determined that the rental equipment is usable and a timing when the desired usage period was accepted is included in the desired usage period. Thereby, in the case where the rental equipment is used on the same day or the like, when a point in time at which the notification of the usage desire was accepted is already within the desired usage period, it is possible to set any password set and input from the user as a password for enabling the rental equipment to be used and it is possible to use the rental equipment more efficiently than in a case where the server 10 issues the password.

Also, the rental equipment management system 1 according to the present embodiment accepts the notification of the desire to use usable rental equipment from the client terminal 20 and the rental equipment when a time period (a desired usage period) in which the user desires to use the rental equipment has been accepted and when there is rental equipment (usable rental equipment) from which the password associated with the desired usage period included in a validity period is not issued. Thereby, when there is usable rental equipment, the notification of the desire to use the rental equipment can be accepted from the client terminal 20 and the rental equipment regardless of the usage reservation and the same-day reservation, and convenience can be improved.

Also, in the rental equipment management system 1 according to the present embodiment, the function of the rental equipment is controlled by the control terminal 30. Thereby, the control terminal 30 can manage the rental equipment and devices such as a notebook-sized personal computer and a projector can be easily used as rental equipment.

Also, in the rental equipment management system 1 according to the present embodiment, a password provided in a notification from the client terminal 20 or the control terminal 30 is acquired as the authentication password. Thereby, it is possible to make a reservation for the rental equipment using either the client terminal 20 or the control terminal 30 and to improve the convenience of the user.

Also, in the rental equipment management system 1 according to the present embodiment, the client terminal 20 is any one of a smartphone, a tablet terminal, and a personal computer. Thereby, it is possible to make a reservation for the rental equipment using a general-purpose terminal device and to improve the convenience of the user.

Also, the rental equipment management system 1 according to the present embodiment determines that the rental equipment is not usable when a reception time at which the input password has been received is outside of a validity period of the authentication password corresponding to the input password. Thereby, because the rental equipment cannot be used unless it is within the validity period, it is possible to prevent unauthorized use of the rental equipment outside the validity period.

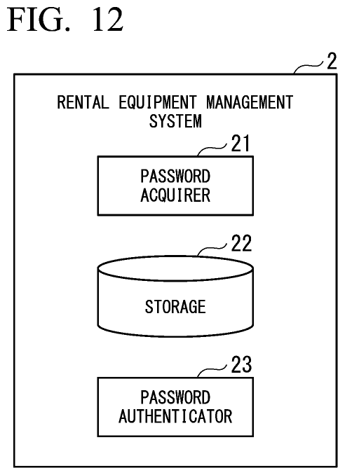

FIG. 12 is a diagram showing a basic configuration of the rental equipment management system according to the present invention.

The basic configuration of the rental equipment management system 2 according to the present invention includes a password acquirer 21, a storage 22, and a password authenticator 23.

The password acquirer 21 acquires a password issued in accordance with reservation acceptance or a password input from the rental equipment when the rental equipment has been rented.

The storage 22 stores the acquired password in association with the equipment identification information of the rental equipment.

The password authenticator 23 receives the password and the equipment identification information from the rental equipment when the rental equipment is used and determines whether or not the rental equipment is usable based on whether or not a combination of the received password and equipment identification information has been stored in the storage.

Also, a program for implementing the functions of the server, the client terminal, and the control terminal in FIG. 1 may be recorded on a computer-readable recording medium and the program recorded on the recording medium may be read and executed by a computer system, such that position detection may be performed. Also, it is assumed that the “computer system” used here includes an operating system (OS) or hardware such as peripheral devices.

Also, the “computer system” is assumed to include a homepage-providing environment (or a display environment) if a WWW system is used.

Also, the “computer-readable recording medium” refers to a flexible disc, a magneto-optical disc, a read-only memory (ROM), a portable medium such as a compact disc-ROM (CD-ROM), or a storage device such as a hard disk embedded in the computer system. Furthermore, the “computer-readable recording medium” is assumed to include a medium that holds a program for a constant period, such as a volatile memory inside a computer system serving as a server or a client. Also, the above-described program may be a program for implementing some of the above-described functions.

Furthermore, the above-described program may be a program capable of implementing the above-described function in combination with a program already recorded on the computer system. Also, the above-described program may be stored in a prescribed server and the program may be distributed (downloaded or the like) via a communication circuit in response to a request from another device.

Although embodiments of the present invention have been described in detail above with reference to the drawings, specific configurations are not limited to the embodiments and other designs and the like may also be included without departing from the scope of the present invention.

### REFERENCE SIGNS LIST

1, 2 Rental equipment management system
10 Server
101 Communicator
102, 22 Storage
103 Website controller
104 Payment processor
105, 21 Password acquirer
106, 23 Password authenticator
107 Terminal controller
108 Clock
109 Validity period updater
110 Notifier
20 Client terminal
30 Control terminal
301 Communicator
302 Function controller
303 Human presence sensor
304 Storage
305 Clock

1. A rental equipment management method comprising:
storing an authentication password for enabling rental equipment to be used in a validity period in a storage in association with equipment identification information of the rental equipment;
receiving an input password input by a user from the rental equipment; and
determining whether or not the rental equipment is usable based on whether or not a combination of the received input password and the equipment identification information is stored in the storage.

2. The rental equipment management method according to claim 1, the equipment management method comprising:
accepting a set password set and input by the user as the authentication password when an issued password to be issued in accordance with a desire to use the rental equipment has not been issued.

3. The rental equipment management method according to claim 2, the equipment management method comprising:
accepting the issued password as the authentication password without accepting the set password when a notification of the desire to use the rental equipment has been accepted from a client terminal different from the rental equipment.

4. The rental equipment management method according to claim 2, the equipment management method comprising:
receiving the set password from the rental equipment.

5. The rental equipment management method according to claim 2, the equipment management method comprising:
determining whether or not the rental equipment is usable from a usage reservation situation of the rental equipment when a desired usage period in which the use of the rental equipment is desired has been accepted; and
accepting the set password as the authentication password when it is determined that the rental equipment is usable and a timing when the desired usage period was accepted is included in the desired usage period.

6. The rental equipment management method according to claim 3, the equipment management method comprising:
accepting the notification of the desire to use usable rental equipment from the client terminal and the rental equipment when a desired usage period in which the rental equipment is desired to be used has been accepted and when there is usable rental equipment from which the authentication password associated with the desired usage period included in a validity period is not issued.

7. The rental equipment management method according to claim 1, the equipment management method comprising:
controlling, by a control terminal, a function of the rental equipment.

8. The rental equipment management method according to claim 7, the equipment management method comprising:
acquiring a password provided in a notification from the control terminal as the authentication password.

9. The rental equipment management method according to claim 3,
wherein the client terminal is any one of a smartphone, a tablet terminal, and a personal computer.

10. The rental equipment management method according to claim 1, the equipment management method comprising:
determining that the rental equipment is not usable when a reception time at which the input password has been received is outside of a validity period of the authentication password corresponding to the input password.

11. A rental equipment management method comprising:
acquiring a password issued in accordance with reservation acceptance or an authentication password that is a password input from rental equipment when the rental equipment has been rented;
storing the acquired authentication password and equipment identification information of the rental equipment in a storage in association with each other;
receiving an input password input by a user and the equipment identification information from the rental equipment when the rental equipment is used; and
determining whether or not the rental equipment is usable based on whether or not a combination of the received input password and the equipment identification information is stored in the storage.

12. The rental equipment management method according to claim 11, the rental equipment management method comprising:
acquiring a detection result from a sensor;
determining whether or not the user is located near the rental equipment based on the detection result of the sensor; and
causing the rental equipment to be in a logoff state when there is no user near the rental equipment.

13. The rental equipment management method according to claim 11, the rental equipment management method comprising:
determining whether or not an extension is possible when an extension request is accepted, and
extending an expiration date set with respect to the authentication password when the extension is possible.

14. The rental equipment management method according to claim 13, the rental equipment management method comprising:
determining that the extension is possible when other rental equipment which is of the same type as the rental equipment is usable.

15. The rental equipment management method according to claim 11, the rental equipment management method comprising:
performing synchronization with a time of the rental equipment; and
causing the rental equipment to be in the logoff state after the expiration date set with respect to the authentication password.

16. The rental equipment management method according to claim 11, the rental equipment management method comprising:
setting a validity period according to a usage period of the rental equipment in the authentication password; and
determining that the rental equipment is usable only when the authentication password corresponding to the received input password is within the validity period.

17. The rental equipment management method according to claim 11, the rental equipment management method comprising:
notifying the user that a period until an expiration date set for the authentication password is shorter than a prescribed period if the period until the expiration date is shorter than the prescribed period.

18. The rental equipment management method according to claim 11, the rental equipment management method comprising:
notifying the user that an expiration date set for the authentication password has passed when the expiration date has passed.

19. A rental equipment management system comprising:
a password acquirer configured to acquire a password issued in accordance with reservation acceptance or an authentication password that is a password input from rental equipment when the rental equipment has been rented;
a storage configured to store the acquired authentication password and equipment identification information of the rental equipment in association with each other; and
a password authenticator configured to receive an input password input by a user and equipment identification information from the rental equipment when the rental equipment is used and determine whether or not the rental equipment is usable based on whether or not a combination of the received input password and the equipment identification information is stored in the storage.
